(19) United States
(12) Patent Application Publication
(10) Pub. No.: US 2006/0169124 A1
(43) Pub. Date: Aug. 3, 2006

(54) Connector assembly for hi-hat stand

(75) Inventor: Yukio Tanaka, Chiba (JP)

Correspondence Address: BERENATO, WHITE & STAVISH, LLC, 6550 ROCK SPRING DRIVE, SUITE 240, BETHESDA, MD, 20817, US

(73) Assignee: PEARL MUSICAL INSTRUMENT CO.

(21) Appl. No.: 11/048,713

(22) Filed: Feb. 3, 2005

(51) Int. Cl. G10D 13/02

(52) U.S. Cl. 84/422.3

(57) ABSTRACT

A hi-hat stand includes an operating rod having first and second rod parts, and a connector assembly coupling the first and second rod parts. The first rod part has a first end portion facing the second rod part and a second end portion connected to a movable cymbal, while the second rod part has a first end portion facing the first rod part and a second end portion operatively connected to a foot pedal of the hi-hat stand. The connector assembly comprises a first connector member for securing to the first end portion of the first rod part, and a second connector member for securing to the first end portion of the second rod part. The first connector member is coupled to the second connector member so as to allow relative rotation therebetween for reducing the stress on an operating member of the hi-hat stand.

### BACKGROUND OF THE INVENTION

1. Field of the Invention

The present inventions relates to hi-hat stands in general, and more particularly to a connector assembly for connecting upper and lower parts of an operating rod of a hi-hat stand.

2. Description of the Prior Art

The integral structure of a hi-hat (or high hat) cymbal stand 10 having a pair of conventional hi-hat cymbals, as shown in FIG. 1, usually includes a support frame 11 supporting a support tube 12, a lower fixed cymbal 14 resting on top of the support tube 12 through a first installation part 16 that fixes the lower fixed cymbal 14 to the support tube 12, an operating or pull rod 18 enclosed within the support tube 12, and an upper movable cymbal 24 is fixed on top of the pull rod 18 through a second installation part 26 that fixes the upper movable cymbal 24 to the operating rod 18. The second installation part 26 has a tightening bolt 27.

A bottom end of the pull rod 18 is connected with a foot pedal 28 of the hi-hat cymbal stand 10. When the pedal 28 is pressed, the pull rod 18 will be pulled downwards to drive the upper cymbal 24 to strike the lower cymbal 14; and when the pedal 28 is released, the pull rod 18 will return upwards to its original position by a restoring elastic device (spring 30) to detach the upper cymbal 24 from the lower one 14. The hi-hat cymbal stand 10 is played when the upper movable cymbal 24 is moved up and down by the operating rod 18 through operation of the foot pedal 28, and moves against the lower fixed cymbal 14 arranged at the top of the support tube 12, for banging cymbals 14 and 24 together or separating them.

Stand legs 32 and 33 are held by the holding members 34 and 35 to the support pipe 12. An operating member 36, such as a chain, is arranged between the foot pedal 28 and the operating rod 18.

The spring 30 continuously biases the operating rod 18 upward. A stopper 37 fixes an upper end of the spring 30 to the operating rod 18. A spring lower end holding member 38 holds a lower end of the spring 30. An engaging bar 39 is provided integrally with the spring lower end holding member 38.

In this kind of high hat stand 110, the operating rod 18 is usually divided into an upper rod part 20 and a lower rod part 22, as shown in FIG. 1. They are freely removably joined by a connecting nut 40. The connection between the upper rod part 20 and the lower rod part 22 is effected by screwing a threaded segment of a lower end portion 21 of the upper rod part 20 and a threaded segment of a top end portion 23 of the lower rod part 22 into a threaded bore 42 of the connecting nut 40.

An upper lock nut 44 is screwed to the top of the connecting nut 40 for securely positioning the connecting nut 40 with respect to the upper rod part 20 of the operating rod 18 and for preventing the upper rod part 20 and the connecting nut 40 from becoming shaky. Similarly, a lower lock nut 46 is screwed to the bottom of the connecting nut 40. If the upper lock nut 44 is not used, the lengths of the threaded segments of the end portions 21 and 23 of the upper and the lower rod parts 20, 22 of the operating rod 18 and the threaded bore 42 of the connecting nut 40 are increased.

The conventional hi-hat stand 110 described above, however, has some shortcomings. For example, during the course of playing, the upper pull rod part 20 often loosens. As a result, the upper rod part 20 and the connecting nut 40 become shaky during a performance, and the up and down movement of the operating rod 18 or the stepping operation of the foot pedal 28 produce disconcerting noise. This happens with such regularity that drummers periodically have to tighten the upper pull rod part 20 into connecting nut 40, in order to maintain proper function of the pull rod 18 of the hi-hat stand. However, if the upper and lower pull rod parts 20 and 22 are already fully engaged, continued tightening of the upper pull rod part 20 and/or the upper lock nut 44 causes the lower pull rod part 22 to turn and puts stress on the chain 36.

Therefore, while known hi-hat operating rod connecting parts, including but not limited to the discussed above, have proven to be acceptable for the hi-hat stands, such devices are nevertheless susceptible to improvements that may enhance their performance. With this in mind, a need exists to develop a connector assembly between first and second parts of an operating rod for a hi-hat stand that advances the art by reducing the stress on the chain, thus allowing longer life and improved durability of the chain and improved reliability of the hi-hat stand.

### SUMMARY OF THE INVENTION

The present invention provides a novel connector assembly between two parts of an operating rod for a hi-hat stand. The hi-hat stand of the present invention includes the operating rod having first and second rod parts, and the connector assembly coupling the first and second rod parts of the operating rod. The first rod part has a first end portion facing the second rod part and a second end portion connected to a movable cymbal, while the second rod part has a first end portion facing the first rod part and a second end portion operatively connected to a foot pedal of the hi-hat stand.

The connector assembly in accordance with the present invention comprises a first connector member provided for securing to the first end portion of the first rod part, and a second connector member provided for securing to the first end portion of the second rod part. Moreover, the first connector member is rotatably coupled to the second connector member so as to allow relative angular movement between the first and second connector members. Thus, the present invention provides the connector assembly for the operating rod of the hi-hat stand that overcomes the drawbacks in the prior art by greatly reducing the stress on an operating member, such as a chain. Consequently, the present invention allows longer life and improved durability of the chain and improved reliability of the hi-hat stand.

This and other advantages of the present invention will be apparent to those of skill in the art when viewed in light of the following description and associated drawings.

### BRIEF DESCRIPTION OF THE DRAWINGS

FIG. 1 is an elevational view of a conventional hi-hat stand according to the prior art;

FIG. 2 is an enlarged cross section of a connector of the hi-hat stand according to the prior art;

FIG. 3 is an elevational view of a hi-hat stand according to a preferred embodiment of the present invention;

FIG. 4 is an elevational view of a connector assembly of the hi-hat stand according to the preferred embodiment of the present invention;

FIG. 5 is a sectional view of the connector assembly according to the preferred embodiment of the present invention;

FIG. 6 is an exploded sectional view of the connector assembly according to the preferred embodiment of the present invention;

FIG. 7 is an elevational view of the connector assembly of the hi-hat stand according to the alternative embodiment of the present invention.

### DETAILED DESCRIPTION OF THE PREFERRED EMBODIMENT

The preferred embodiment of the present invention will now be described with the reference to accompanying drawings.

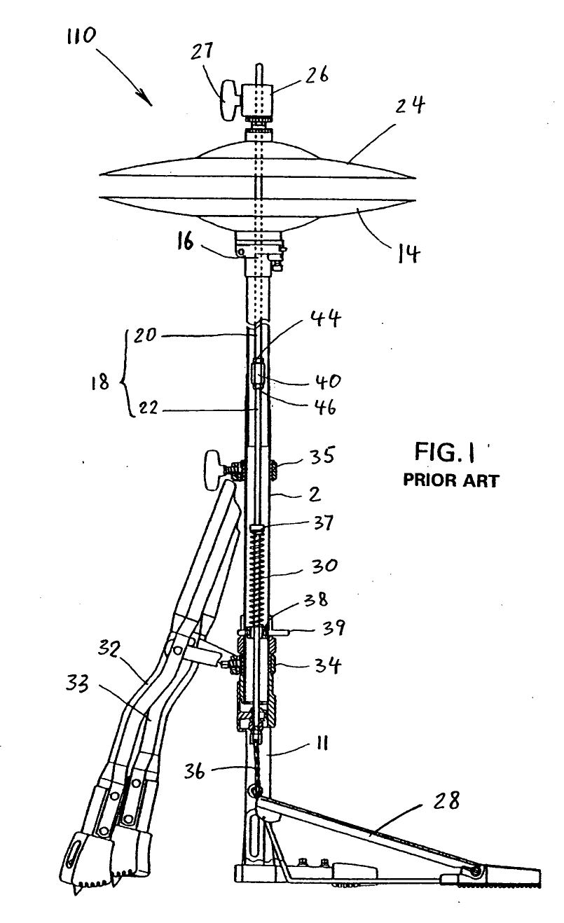

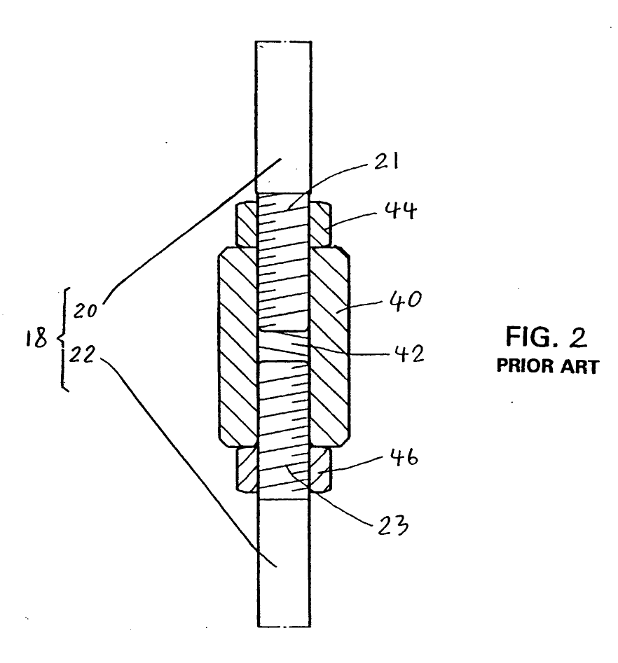

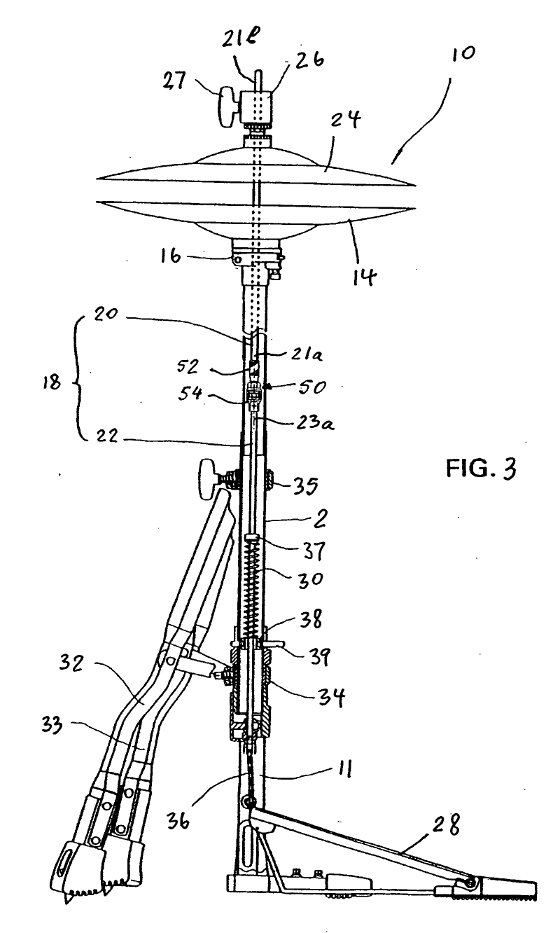

A high hat stand 10 of the present invention, shown in FIG. 3, has substantially the same structure as the conventional high hat stand 110 of the prior art illustrated in FIGS. 1 and 2 except for the structure of a connector assembly 50 in the operating or pull rod 18. Therefore, only the connector assembly 50, which differs, will be explained in detail below. Components, which are unchanged from, or function in the same way as in the embodiment depicted in FIGS. 1 and 3 are labeled with the same reference numerals.

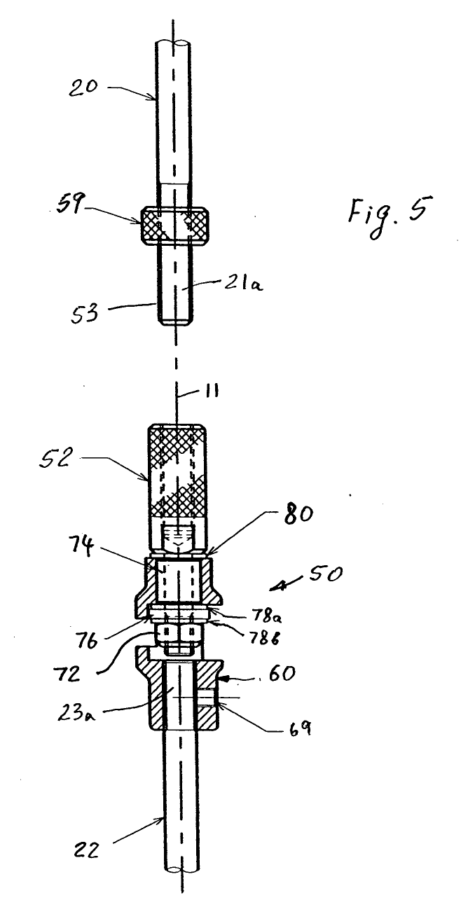

In the high hat stand 10, the operating rod 18 mounted to the upper movable cymbal 24 is moved up and down by operation of the foot pedal 28 to bang the upper cymbal 24 on the lower fixed cymbal 14. The operating rod 18 is divided into the upper or first rod part 20 and the lower or second rod part 22 which are freely separably joined by the connector assembly 50 of the present invention. As shown in FIGS. 3-5, the first and second rod parts 20 and 22 are mounted substantially coaxially along a central axis 17 of the operating rod 18.

As illustrated in FIG. 3, the first rod part 20 has a first end portion 21 a facing the second rod part 22 and a second end portion 21b connected to the movable cymbal 24 through a second installation part 26. Preferably, the first end portion 21a of the first rod part 20 has a threaded section 53. Similarly, the second rod part 22 has a first end portion 23a facing the first rod part 20 and a second end portion 23b operatively connected to a foot pedal 28 of the hi-hat stand 10 through an operating member, preferably a chain, 36.

The connector assembly 50 of the operating rod 18 comprises a first connector member 52 and a second connector member 60 rotatably coupled to the first connector member 52 so as to allow relative angular movement between the first and second connector members 52 and 60, respectively. The first connector member 52 is adapted to be secured to the first end portion 21a of the first rod part 20, while the second connector member 60 is adapted to be secured to the first end portion 23a of the second rod part 22. Preferably, as illustrated, the first connector member 52 and the second connector member 60 are substantially coaxial to the central axis 17.

More specifically, according to the preferred embodiment of the present invention, the first connector member 52 is a male connector member and includes a body portion 54 and a pin portion 56 outwardly extending from the body portion toward the first end portion 23a of the second rod part 22. The body portion 54 is provided with a threaded bore 55 adapted to threadedly receive the threaded section 53 of the first end portion 21a of the first rod part 20, thus drivingly coupling the connector assembly 50 to the first rod part 20 of the operating rod 18. The high hat stand 10 of the present invention may further include a locknut 59. The pin portion 56 of the first connector member 52 has a threaded section 57a at the distal end thereof and a non-threaded section 57b adjacent to the body portion 54. Preferably, the body portion 54 of the first connector member 52 is knurled on its outer peripheral surface to provide a reliable of grip.

The second connector member 60 is a female connector member and includes a hollow body 62 defining a cavity 63 and having an access window 64 providing an access into the cavity 63, a rod bore 66 adapted to receive the first end portion 23a of the second rod part 22, and a connector bore 68 adapted to receive the pin portion 56 of the first or male connector member 52 therein. The hollow body 62 of the second connector member 60 further includes a gripping portion 70 about the connector bore 68, preferably having a hexagonal cross-section adapted to be engaged with a wrench (not shown). A transverse set screw hole 67 extends through the hollow body 62 perpendicularly to the central axis 17 and into the rod bore 66. A set screw 69 is inserted into the set screw hole 67 to secure the first end portion 23a of the second rod part 22 in the rod bore 66 of the hollow body 62.

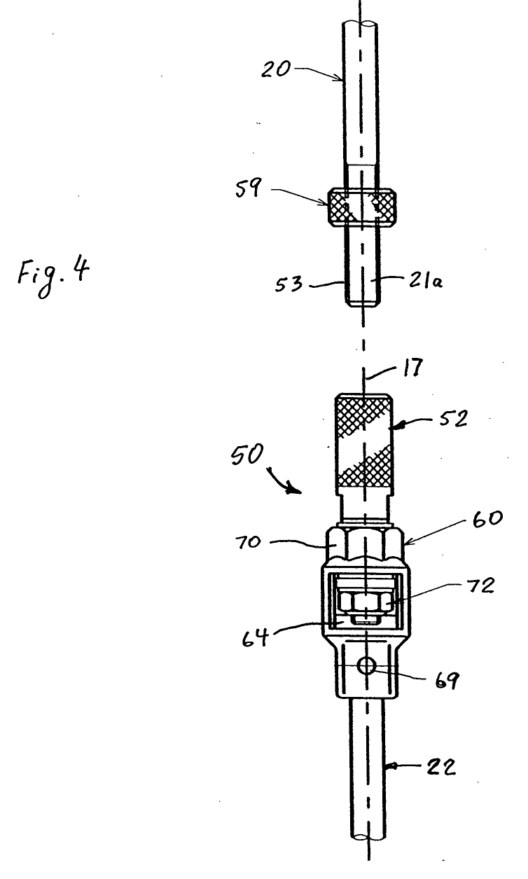

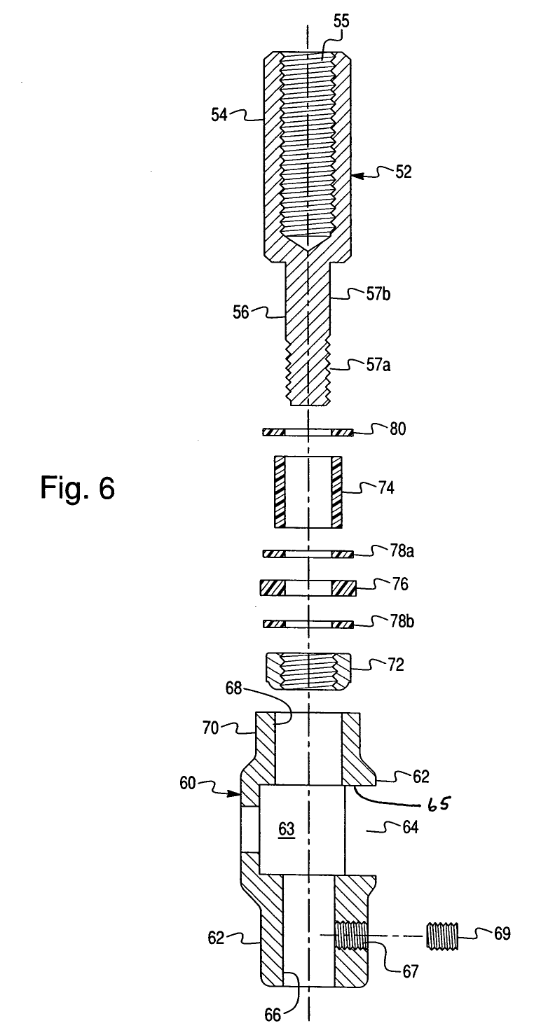

In an assembled condition of the connector assembly 50, the pin portion 56 of the first connector member 52 extends into the cavity 63 within the hollow body 62 through the connector bore 68. The connector assembly 50 further includes a bushing 74 provided between the pin portion 56 and an inner peripheral surface of the connector bore 68 and mounted substantially about the non-threaded section 57b of the pin portion 56. Preferably, the bushing 74 is made of a low friction material, such as plastic. The first connector member 52 is secured to the second connector member 60 by a nut member 72 threadedly engaging the threaded section 57a of the pin portion 56 of the first connector member 52. Furthermore, connector assembly 50 according to the preferred embodiment of the present invention includes a set of washers including a rubber washer 76 sandwiched between a pair of fiber washers 78a and 78b. As shown in FIGS. 4-6, the washers 76, 78a and 78b are larger in diameter than the connector bore 68 in the hollow body 62 so as to be sandwiched between a nut member 72 and a support land 65 (shown in FIG. 6) formed on the hollow body 62 within the cavity 63.

Moreover, in order to further reduce friction between the first connector member 52 and the second connector member 60, the connector assembly 50 further includes a washer 80, such as a fiber washer, disposed between the body portion 54 of the first connector member 52 and the hollow body 62 of the second connector member 60.

During the assembly of the connector assembly 50, the access window 64 provides an access into the cavity 63 for the nut 72, the washers 76, 78a and 78b, and the assembling wrench (not shown).

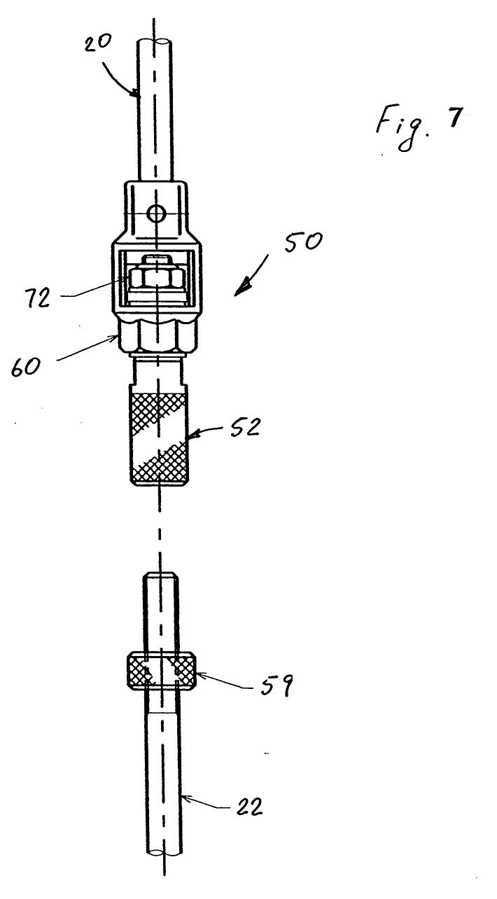

One of ordinary skill in the art would appreciate that alternatively the first or male connector member could be attached to the first end 23a of the second rod part 22 and the second or female connector member attached to the first end 21a of the first rod part 20, as illustrated in FIG. 7.

The above described arrangement of the connector assembly 50 allows relative rotation between the first connector member 52 and the second connector member 60 about the central axis 17 to prevent stress on the chain 36. The ability of the connector assembly 50 to spin greatly reduces the stress on the chain 36, thus allowing longer life and improved durability of the chain 36 and improved reliability of the hi-hat stand 10. The described connector assembly is of simple construction, easy to assemble and is effective in use.

The foregoing description of the preferred embodiment of the present invention has been presented for the purpose of illustration in accordance with the provisions of the Patent Statutes. It is not intended to be exhaustive or to limit the invention to the precise forms disclosed. Obvious modifications or variations are possible in light of the above teachings. The embodiments disclosed hereinabove were chosen in order to best illustrate the principles of the present invention and its practical application to thereby enable those of ordinary skill in the art to best utilize the invention in various embodiments and with various modifications as are suited to the particular use contemplated, as long as the principles described herein are followed. Thus, changes can be made in the above-described invention without departing from the intent and scope thereof. It is also intended that the scope of the present invention be defined by the claims appended thereto.

What is claimed is:

1. A connector assembly between first and second rod parts of an operating rod of a hi-hat stand, said first rod part having a first end portion facing said second rod part and a second end portion connected to a movable cymbal, said second rod part having a first end portion facing said first rod part and a second end portion operatively connected to a foot pedal of said hi-hat stand, said connector assembly comprising:
a first connector member provided for securing to said first end portion of said first rod part; and
a second connector member provided for securing to said first end portion of said second rod part;
said first connector member being rotatably coupled to said second connector member so as to allow relative angular movement between said first and second connector members.

2. The connector assembly as defined in claim 1, wherein said first end portion of said first rod part is secured to said first connector member by a threaded connection.

3. The connector assembly as defined in claim 2, wherein said first connector member has a threaded bore complementary to said first end portion of said first rod part.

4. The connector assembly as defined in claim 1, wherein said second connector member has a rod bore complementary to said first end portion of said second rod part.

5. The connector assembly as defined in claim 4, further comprising a set screw passing through a set screw opening in said second connector member and into said rod bore for engaging said first end portion of said second rod part.

6. The connector assembly as defined in claim 1, wherein said first connector member includes a body portion and a pin portion outwardly extending from said body portion so that said pin portion engages said second connector member.

7. The connector assembly as defined in claim 6, wherein said second connector member includes a hollow body defining a cavity and having an access window providing an access into said cavity and a connector bore adapted to receive said pin portion of said first connector member therein, said pin portion extending into said cavity in said second connector member.

8. The connector assembly as defined in claim 7, further including a fastener member engaging said pin portion of said first connector member for rotatably securing said first connector member to said second connector member.

9. The connector assembly as defined in claim 8, wherein said hollow body of said second connector member has an access window providing an access into said cavity for said fastener member.

10. The connector assembly as defined in claim 8, wherein said pin portion of said first connector member has a threaded section at the distal end thereof and a non-threaded section adjacent to said body portion, and wherein said fastener member is an internally threaded nut member threadedly engaging said threaded section of said pin portion of said first connector member.

11. The connector assembly as defined in claim 8, further including a bushing provided between said pin portion and an inner peripheral surface of said connector bore and mounted substantially about said pin portion of said first connector member.

12. The connector assembly as defined in claim 11, wherein said bushing is made of a low friction material.

13. The connector assembly as defined in claim 8, further including at least one washer mounted to said pin portion of said first connector member within said cavity between said fastener member and said second connector member.

14. The connector assembly as defined in claim 13, wherein said at least one washer includes a rubber washer disposed between two fiber washers.

15. The connector assembly as defined in claim 8, further including at least one washer mounted to said pin portion of said first connector member outside said cavity between said body portion of said first connector member and said second connector member.

16. The connector assembly as defined in claim 15, wherein said at least one washer is made of a low friction material.

17. The connector assembly as defined in claim 6, wherein said body portion of said first connector member has a threaded bore complementary to a threaded first end portion of said first rod part.

18. The connector assembly as defined in claim 7, wherein said hollow body of said of said second connector member has a rod bore complementary to said first end portion of said second rod part.

19. The connector assembly as defined in claim 18, further comprising a set screw passing through a set screw opening in said hollow body of said second connector member and into said rod bore for engaging said first end portion of said second rod part.
